(19) United States
(12) Patent Application Publication
(10) Pub. No.: US 2009/0153887 A1
(43) Pub. Date: Jun. 18, 2009

(54) APPARATUS FOR PRINTING CONSISTENT SPOT COLORS

(75) Inventors: Guo-Yau LIN, Fairport, NY (US); Timothy John MOUSAW, Rochester, NY (US); Sharon Anne KRUEGER, Penfield, NY (US); Mark VAN DELLON, Webster, NY (US); Kenneth R. MILLER, Macedon, NY (US)

Correspondence Address: OLIFF & BERRIDGE, PLC., P.O. BOX 320850, ALEXANDRIA, VA, 22320-4850, US

(73) Assignee: XEROX CORPORATION, Norwalk, CT (US)

(21) Appl. No.: 11/957,646

(22) Filed: Dec. 17, 2007

(51) Int. Cl. G06F 15/00

(52) U.S. Cl. 358/1.9

(57) ABSTRACT

RE A color imaging system is provided with a tagging system that tags spot color pixels in a page description language differently from non-spot color pixels. These tags are generated in a digital front end and stored along with contone values in a data structure. In addition to the tags, a rendering hint remap table and a user TRC remap table are used to bypass applying TRCs to spot colors.

### BACKGROUND

This disclosure generally relates to color imaging systems, such as printers, copiers and other color imaging systems and specifically relates to printing spot colors consistently in a color imaging system.

In today's business and scientific world, color has become essential as a component of communication. Color facilitates the sharing of knowledge and ideas. Inventors, who develop color imaging systems, find innovative ways to improve the technology, for machines and processes for printing color images, which may be used by businesses and people to share knowledge and ideas.

Color imaging systems, such as printers commonly provide a limited number of output possibilities and the output possibilities are typically binary. For example, a printer produces either a dot (1) or no dot (0) at a given pixel location. Given a color separation with 256 shades of each additive primary color, a set (or array) of binary printer signals may be produced, representing a contone effect. This process is referred to as halftone image processing or halftoning.

In halftoning, each pixel value of an array of contone pixels within a given area of a color image is compared to one of a set of pre-selected thresholds. These thresholds may be stored as a dither matrix and the repetitive pattern generated by this matrix is considered a halftone cell as taught, for example, in U.S. Pat. No. 4,149,194 to Holladay. In practice, some of the thresholds in the matrix will be exceeded for an area where the image is a contone. In other words, the image value at that specific location will be larger than the value stored in the dither matrix for that same location, while at other locations, the values will not exceed the thresholds in the matrix. In the binary case, the pixels or cell elements for which the thresholds are exceeded might be printed as black or some other color, while the remaining elements are allowed to remain white or uncolored, dependent on the actual physical quantity described by the data. Because the human visual system tends to average out rapidly varying spatial patterns and perceives only a spatial average of the micro-variations in spot color produced by a printer, the halftone process may be used to produce a close approximation to the desired color in the contone input. Each color separation of an image may be halftoned sequentially to render or form the full color image.

In addition to process color images, spot color and/or high-fidelity images may be produced by color imaging systems. Process color images may be augmented with additional primary colors beyond the usual four primaries colors (i.e., CMYK) typically used to produce the process color output. These additional colors extend the color gamut of the process color output to produce high fidelity color for a color imaging system and thereby more closely emulate standardized spot colors, such as those defined by Pantone.

A color imaging system, such as a printer typically includes an output device called an image output terminal (IOT) that is generally capable of producing color and back-and-white tones to produce images. Some examples of IOTs include xerographic print engines, thermal inkjet devices and the like. The color imaging system typically accepts color level specifications for each of four or more colors. such as CMYK as input and produces color images as output using halftoning to print a fine pattern of color spots. The spots are grouped together to form dots, which appear as varying color tones in accordance with the number of color spots used when viewed from a distance.

A color imaging system, such as a printer may be calibrated so that it operates to produce relatively consistent output in an operating environment having parameters such as, for example, specific humidity, temperature, dust count, etc. If one or more of the desired operating parameters deviate from the desired operating parameters, the printer may drift away from ideal conditions. One way to compensate for the drift within the printer includes modifying data within a digital front end (DFE) in the color imaging system. The digital front end converts image data (e.g., PostScript and PDF) into raster data, which is transmitted to the image output terminal (IOT) that produces the color image. A tone reproduction curve (TRC) may modify the raster data before it is sent to the image output terminal. A TRC is an electronic map or a graphic representation of a relationship of input image data to output image data. The TRC is used to convert input image data into image output data. The TRC may be calibrated as part of calibrating the whole color imaging system. During calibration, a test suite of grey patches may be printed from known image values and then the resulting test patches may be measured (for example, by using a calorimeter or spectrophotometer) to determine the actual printed image values. A calibration TRC is generated by determining the difference between the known and the actual image values. The calibration TRC may therefore be used to correct for drift and/or other factors.

During image processing, input image data is typically described in a page description language (PDL), such as PostScript or PDF. Nearly all page description languages include a set of programming language commands for processing the image data. The page description language is processed (or interpreted) by a color imaging system so that the proper type and sequence of color images are printed. The process of converting input image data into pixel display values arranged in a frame buffer for ready use by a print engine is called rendering an image.

Pixel display values may be associated with tag information that classifies portions of an image according to object types. U.S. Pat. No. 6,429,950 by Ebner discloses a method and apparatus for registering object characterization information in the form of tags appended to pixel display values stored in the frame buffer of an imaging system using page description language commands. The page description language commands are used to generate and register the tag information on a per-pixel level in the frame buffer based on the object type of imaging data derived from the page description language data received into the imaging system. The pixel data image tagging is useful to differentiate between bit maps, text, line art, graphics (including fills and sweeps), and images in gray scale, RGB, CMYK and other color space frame buffers to enable per-pixel segmentation tags.

When printing spot colors, color fidelity is important. Color fidelity means that colors consistently look the same (e.g., match a standard color) regardless of how they are printed. In principle, user TRC should not affect spot color output, and the fidelity of the spot colors should be solely maintained by the calibration TRC, but existing image processing systems do not maintain the color fidelity of spot colors due to the involvement of the user TRC. To date, all known attempts to print consistent spot colors have been inefficient. For example, one known method includes pre-compensating for the user TRC by embedding an inverse user TRC mapping in the contone values for the spot colors and sending pre-compensated spot colors to the printer. First, the concatenation of the inverse TRC and the user TRC create a loss of output levels. That is, the spot colors might not be the same as that in the original recipe. Second, because a user TRC is usually iteratively designed, the spot colors have to be iteratively re-compensated. Finally, if a print job was raster image processed (RIPped) and saved with one user tone reproduction curve and ifs at the reprint time, that user TRC is not needed or a new TRC is demanded, then it may be necessary to re-raster image process the job and redo the pre-compensation process for the spot colors all over again. Such a workflow is inefficient.

### SUMMARY

Exemplary embodiments of the disclosure provide an apparatus and method for printing consistent spot colors. The apparatus may include a remap mechanism in a digital front end and an image output terminal. The remap mechanism bypasses application of a user TRC for at least one spot color in a color image by using tags associated with the spot color in image data. The digital front end processes the image data and generates printer data. The printer data effects the bypass of the user TRC for the spot color. The image output terminal receive the printer data from the digital front end and generates the color image, resulting in the spot color in the color image not being effected by the user TRC.

The apparatus may include a storage device associated with the remap mechanism for storing the image data and/or printer data. The apparatus may also include circuitry in the remap mechanism for loading a user TRC, a user tone reproduction remap table, a rendering hint remap table and a calibration TRC into the storage device. The rendering hint remap table may be generated by the digital front end based on a halftone selection. A tag and contone value may be associated with each pixel in a data structure for the color image. The remap mechanism may processes a pixel having a tag that is allocated for a spot color by indexing into the user tone reproduction remap table and instructing the circuitry whether to apply the user TRC on the contone value. The circuitry bypasses applying the user TRC for the pixel for the spot color. A xerographic device may include such an apparatus.

### BRIEF DESCRIPTION OF THE DRAWINGS

FIG. 1 illustrates an exemplary embodiment of a color imaging system for printing consistent spot colors;

FIG. 2 illustrates an exemplary embodiment of a hardware schema for remap architecture (per separation) for a circuit that may be implemented in the color imaging system of FIG. 1;

FIG. 3 illustrates an exemplary embodiment of a rendering hint remap table;

FIG. 4 illustrates an exemplary embodiment of a rendering hint remap table when there is a constraint in doubling the number of the existing hints; and

FIG. 5 illustrates exemplary embodiments of the two remap tables: the user TRC remap table and the rendering hint remap table.

### EMBODIMENTS

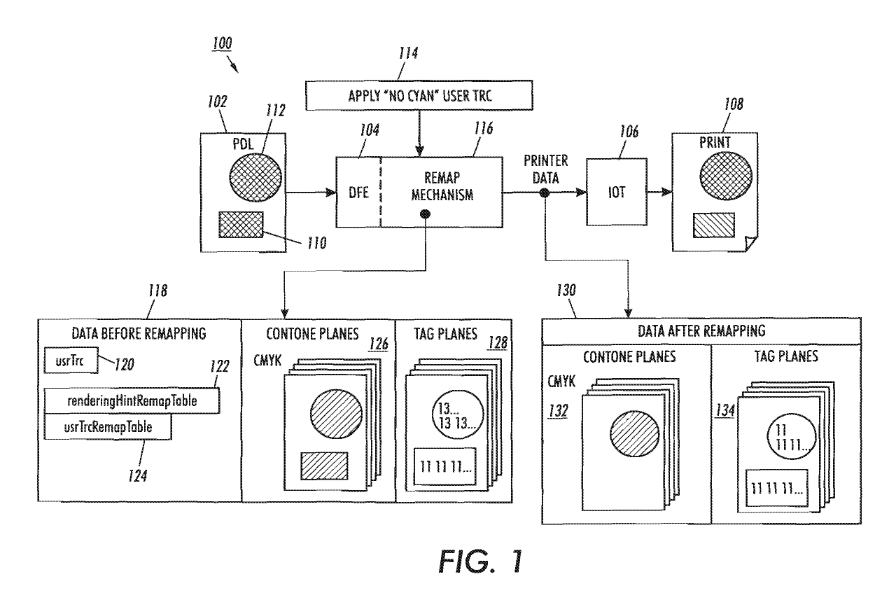

FIG. 1 illustrates an exemplary embodiment of a color imaging system 100 for printing consistent spot colors, The color imaging system 100 receives input information 102 about a color image in, for example, a page description language (PDL) file. The input information 102 is processed by a digital front end (DFE) 104 to generate printer data for an image output terminal (IOT) 106 that produces a print output 108 of the color image. In this example, the input information 102 describes a color image that has both a non-spot color 110 and a spot color 112. In this example, a request to apply a “no cyan” user TRC 114 is received by the digital front end 104. The digital front end 104 includes a remap mechanism 116. Intermediate data 118 is associated with the color image before remapping and includes the user TRC 120, a rendering hint remap table 122 and a user TRC remap table 124 as well as contone planes 126 and tag planes 128 for the color separations. Printer data 130 is associated with the color image after remapping and includes modified contone planes 132 and tag planes 134 for the color separations.

The color imaging system 100 processes the input information 102 in a way that enables consistent spot color printing, regardless of whether a user TRC (e.g., “no cyan”) is applied. In FIG. 1, the digital front end 104 creates printer data for the image output terminal 106 by decomposing, color transforming and look-up, flattening and rasterizing the input information 102 to generate compressed data. In one embodiment, the data is in XM2 format, which is a Xerox proprietary print data format U.S. Pat. No. 7,003,585) containing contone planes, tag planes, and related information in the header. The compressed data is then decompressed and passed through the remap mechanism 116. The remapped data is then passed to the image output terminal 106.

During the decomposition process, the digital front end 104 may recognize spot color objects and assign a special spot color intent to pixels that are associated with the spot color objects. Later on, when the digital front end 104 generates the rasterized data, the digital front end 104 assigns appropriate tags for each pixel of the color image based on whether the special spot color intent was assigned for that pixel.

The data 118, 130 generated by the digital front end 104 may include contone planes 126, 132, tag planes 128, 134, user TRCs 120, rendering hint remap tables 122 and user TRC remap tables 124. The data 118, 130 maybe stored in a storage device for future printing or reprinting. After processing by the remap mechanism 116 in the digital front end 104, the data 130 includes tone corrected contone values and remapped tags, which are sent to the image output terminal 106 for printing. The image output terminal 106 halftones the final contone values using halftone screens specified in the tags.

FIG. 1 illustrates an example of an unlikely case where a user TRC 120 is applied in the digital front end 104 that maps all cyan contone values to zero. This extreme example was chosen to demonstrate the consistent spot color printing of the color imaging system 100. One would expect that the result of applying the “no cyan” user TRC 114 would be to remove cyan from the non-spot color objects on the print output 108 and leave cyan in the spot color objects on the print output 108. In the input information 102 shown in FIG. 1, both the spot color 112 (circle) and the non-spot color 110 (rectangle) represent similar “bluish” colors, while in the print output 108 shown in FIG. 1, the spot color (circle) has the same “bluish” color as the input information 102 but the non-spot color is magenta. This is because the “no cyan” user TRC 114 was applied to the non-spot color but not the spot color. The data 118 before the remapping includes a cyan contone plane 126 for both the spot color (circle) and non-spot color (rectangle). After the remapping, the data 130 includes a cyan contone plane 132 only for the spot color (circle), not the non-spot color (rectangle). Consequently, in the print output 108 the spot color (circle) is “bluish” while the non-spot color (rectangle) is magenta.

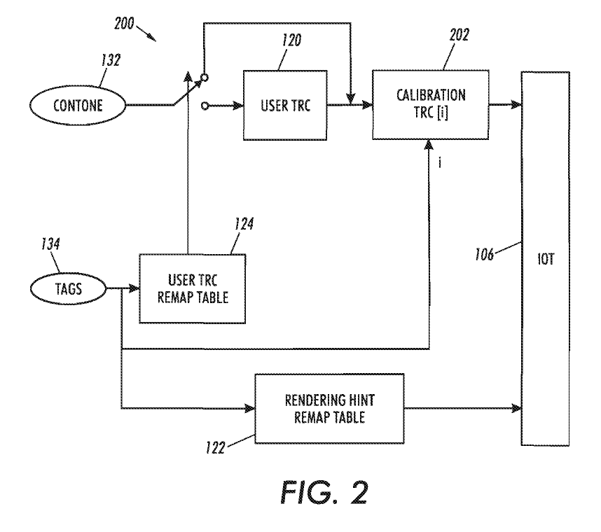

FIG. 2 illustrates an exemplary embodiment of a hardware schema for remap architecture (per separation) for a circuit 200 that may be implemented in the remap mechanism 116 in the digital front end 104 (see FIG. 1). Each pixel in a frame buffer contains a contone value and a tag for each of the separations. Once intermediate data 118 is generated in the digital front end, the user TRC remap table 124 and the rendering hint remap table 122 are loaded into the appropriate locations in the remap mechanism 116. In the meantime, the user TRCs 120 and a series of calibration TRCs 202, which are selected based on the values in the rendering hint remap table 122, are also loaded into the appropriate locations in the remap mechanism 116.

The rendering hint remap table 122 is generated by the digital front end 104 based on the halftone selection. The rendering hint remap table 122 is used to instruct the hardware what calibration TRCs to load for each available calibration TRC slot. The rendering hint remap table 122 is also used to remap the incoming tag (or hint) to the real image output terminal tag that represents the halftone on the printer. For example, the rendering hint remap table may have “t” at multiple indices, which means the incoming tags with those index values will be mapped to “t” (i.e., using the same halftone) in hardware before the remapped data is sent to the printer. in one exemplary embodiment of the color image system 100, the rendering hint remap table is a length sixteen array to accommodate the incoming tag 134 (or hint) values that range from zero to fifteen.

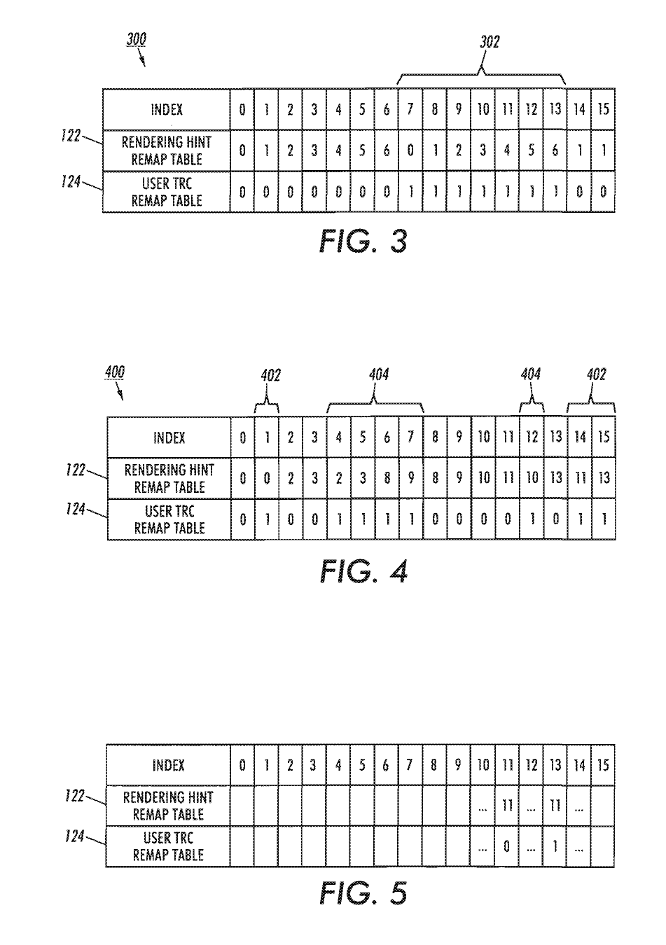

FIG. 3 illustrates an exemplary embodiment 300 of a rendering hint remap table 122. In this simplified example, the image output terminal 106 only recognizes and uses the tags zero through six. Each tag represents a specific halftone screen. When the user TRC is bypassed (not applied) for a spot color, the digital front end 104 uses tags 7-13 for spot colors. On the hardware, where the remapping occurs, the rendering hint remap table 122 is used to remap 7-13 to 0-6, respectively. In this simple example 300, the table entries at indices 14 and 15 are not used at all and are treated as a “don't care” tag, which is mapped to the default tag (e.g., 1).

On some image output terminals 106, there are more hints than the simplified example in FIG. 3 can accommodate. In that case, it is not possible to simply double the number of digital front end hints to distinguish between spot color pixels and non-spot color pixels. Instead, the information pertaining to the halftone selection (either for the queue, job, or page) is used and hints that are not used are ignored when a specific halftone dot is selected. For example, if the 175 dot is selected, the entries for the 150 dot and the stochastic dot may be freed up. This is under the assumption that when the 175 dot is used, it is not desirable to see any objects that are rendered with the 150 dot and the stochastic dot.

FIG. 4 illustrates an exemplary embodiment 400 of a rendering hint remap table when there is a constraint in doubling the number of the existing hints. Areas 402 are used for spot color pixels. The hints in areas 402 (i.e., columns 14 and 15) are not used and the hints in areas 404 (i.e., columns 1, 4-7 and 12) are ignored based on the halftone selection for the page. Entries in both areas 402, 404 are used for the spot color pixels and each of them is eventually mapped to entries in the other areas (i.e., columns 0, 2, 3, 8-11 and 13).

FIG. 5 illustrates exemplary embodiments of the two remap tables: the user TRC remap table 124 and the rendering hint remap table 122. The user TRC remap table 124 is used to determine whether a pixel with a particular tag should cause the circuit 200 to bypass the user TRC 120 (see FIG. 2). In this example, the user TRC remap table 124 contains 0's and 1's, where 0 means that the pixel is a non-spot color and should be adjusted with the user TRC 120 and 1 means that the pixel is a spot color and should bypass the user TRC 120.

The user TRC remap table 124 is first created by the digital front end 104 and then passed and loaded onto the user TRC remap table slot in the remap mechanism 116. When the remap mechanism 116 is processing a pixel with a tag that is allocated for spot colors, the remap mechanism 116 indexes into the user tone reproduction remap table 124 to find a value of 1 and therefore instructs the circuit 200 to bypass the user TRC 120. When the remap mechanism 116 is processing a pixel with a tag that is allocated for non-spot colors, the remap mechanism 116 indexes into the user TRC remap table to find a value of 0 and therefore instructs the circuit 200 to apply the user TRC 120 on the input contone values.

In the color imaging system 100 of FIG. 1, if the 200 dot halftone, which is recognized as tag 11 on the image output terminal 106 is selected, then the digital front end 104 generates a tag values of 11 for non-spot color pixels and a tag value of 13 for spot color pixels. The rendering hint remap table 122 is constructed as illustrated in FIG. 5 to have the value 13 for both indices 11 and 13. The 200 dot calibration TRC is loaded at the 11^{th} and 13^{th} calibration tone reproduction slots in the remap mechanism 116. As a result, the 200 dot calibration TRC is applied on the pixels that have tags 11 or 13. The number “1” in the user TRC remap table 124 indicates that the pixels that have tag 13 in the XM2 are spot color pixels which, in turn, indicates to the circuit 200 to bypass the user TRC 120 for the pixels that have tag 13. FIG. 3 shows area 302 where the TRC remap table 124 has the value “1”.

The remap mechanism 116 may be implemented on an image output terminal board hardware and in a driver on the digital front end 104. The compression/decompression may be implemented on a separate board. The remap mechanism 116 may be implemented in hardware, software, ant/or firmware.

The existence of the user TRC remap table 124 is optional, since it can be generated by examining the rendering hint remap table 122. For example, the user TRC remap table value would be one (1) if the index value and the rendering hint remap table value are different (see FIG. 3), and the user TRC remap table value would be zero (0) if the index value and the rendering hint remap table value are the same. Note that this rule will make the user TRC remap table value equal one at indices 14 and 15. However this is acceptable since indices 14 and 15 are “don't-care” indices. ?Exemplary embodiments have many advantages, including no need for pre-compensating spot colors according to the user TRC 120 that are going to be applied. When saving and reprinting an image, there is no need to re-RIP the job when a different or user TRC is demanded. Additional advantages include a more efficient workflow and that modification of spot colors is independent of other color settings (e.g., user TRCs).

It will be appreciated that various of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art, and are also intended to be encompassed by the following claims.

What is claimed is:

1. An apparatus for printing consistent spot colors, comprising:
a remap mechanism for bypassing application of a user tone reproduction curve (TRC) for at least one spot color in a color image by using at least one tag, associated with the at least one spot color, in image data;
a digital front end, including the remap mechanism, for processing the image data to generate printer data, the printer data affecting the bypass of the user TRC for the at least one spot color; and
an image output terminal in communication with the digital front end for receiving the printer data and generating the color image, resulting in the at least one spot color in the color image not being effected by the user TRC.

2. The apparatus of claim 1, further comprising:
a storage device associated with the remap mechanism for storing the image data.

3. The apparatus of claim 2, wherein the storage device stores the printer data.

4. The apparatus of claim 2, further comprising:
circuitry in the remap mechanism for loading a user TRC, a user TRC remap table, a rendering hint remap table and at least one calibration TRC into the storage device.

5. The apparatus of claim 4, wherein the rendering hint remap table is predetermined and at least one appropriate calibration TRC is selected by the digital front end based on a halftone selection.

6. The apparatus of claim 1, wherein the at least one tag is associated with each of a plurality of pixels in a data structure for the color image.

7. The apparatus of claim 6, wherein a contone value is associated with each of the pixels in the data structure for the color image.

8. The apparatus of claim 7, wherein the remap mechanism processes a pixel having a tag that is allocated for a spot color by indexing into the user TRC remap table and instructing the circuitry whether to apply the user TRC on the contone value.

9. The apparatus of claim 8, wherein the circuitry bypasses applying the user TRC for each pixel tagged for a spot color.

10. An xerographic device, comprising the apparatus of claim 1.

11. A method for printing consistent sport colors, comprising:
bypassing application of a user tone reproduction curve (TRC) for at least one spot color in a color image with a remap mechanism by using at least one tag associated with the at least one spot color in image data;
processing the image data to generate printer data with a digital front end including the remap mechanism, the printer data affecting the bypass of the user TRC for the at least one spot color;
receiving the printer data with an image output terminal in communication with the digital front end and generating the color image, resulting in the at least one spot color in the color image not being effected by the user TRC.

12. The method of claim 11, further comprising:
storing image data in a storage device associated with the remap mechanism.

13. The method of claim 12, further comprising:
storing the printer data in the storage device.

14. The method of claim 12, further comprising:
loading a user TRC, a user TRC remap table, a rendering hint remap table and at least one calibration TRC into the storage device with circuitry in the remap mechanism.

15. The method of claim 14, further comprising:
generating the rendering hint remap table by the digital front end based on a halftone selection.

16. The method of claim 11, further comprising:
associating the at least one tag with each of a plurality of pixels in a data structure for the color image.

17. The method of claim 16, further comprising:
associating a contone value with each of the pixels in the data structure for the color image.

18. The method of claim 17, further comprising:
processing a pixel having a tag that is allocated for a spot color with the remap mechanism by indexing into the user TRC remap table.

19. The method of claim 18, further comprising:
instructing processing circuitry whether to apply the user TRC on the contone value with the remap mechanism.

20. The method of claim 19, further comprising:
bypassing applying the user TRC for each pixel tagged for the spot color.

21. The method of claim 4, wherein the user TRC remap table is generated based on examining the rendering hint remap table;
wherein a value of one (1) is assigned to the user TRC remap table if the index is different from a rendering hint remap table value, and
a value of zero (0) is assigned to the user TRC remap table if the index is the same as the rendering hint remap table value.
